(19) United States
(12) Patent Application Publication
(10) Pub. No.: US 2008/0203186 A1
(43) Pub. Date: Aug. 28, 2008

(54) MISTING DEVICE

(75) Inventor: Ursula GROCKE, Novelty, OH (US)

Correspondence Address: CALFEE HALTER & GRISWOLD, LLP, 800 SUPERIOR AVENUE, SUITE 1400, CLEVELAND, OH, 44114, US

(73) Assignee: FOARA INTERNATIONAL, LLC, Novelty, OH (US)

(21) Appl. No.: 12/038,380

(22) Filed: Feb. 27, 2008

Related U.S. Application Data
(60) Provisional application No. 60/891,791, filed on Feb. 27, 2007.

(51) Int. Cl. B05B 9/03; B05B 1/10; B05B 3/00; B05B 12/02; B05B 13/04

(52) U.S. Cl. 239/70; 239/140; 239/281; 239/302

(57) ABSTRACT

A misting device capable of selectively spraying a fluid mist to cool an area or an individual(s) and/or promote health and wellness of the individual(s). The misting device includes a body, a pump and one or more fluid reservoirs disposed in the body, a spray arm extending from the body, and one or more misting nozzles supported by the spray arm. The body is adapted to support the device on a surface and the spray arm and nozzles are movable to adjust the direction of the mist exiting the nozzles.

### RELATED APPLICATIONS

This application claims priority to and the benefit of U.S. provisional patent application No. 60/891,791, filed on Feb. 27, 2007, for MISTING DEVICE, the entire disclosure of which is fully incorporated herein by reference.

### BACKGROUND

Sunbathing is a common activity in which an individual lays in the sun in order to obtain a suntan. Lying in the sun for a prolonged period of time, however, may result in the individual becoming uncomfortably warm. Sprinkling or misting water on the individual while sunbathing can cool the individual. Misting plants

Furthermore, misting water or some other fluid(s) on an individual, or toward a particular area, can provide wellness benefits. For example, the fluid being misted may include additives to enhance health and wellness, such as, but not limited to, aromatherapy additives (e.g. essential oils, floral waters, hydrosols, etc.) and skin care additives (e.g. certain vitamins and minerals).

### SUMMARY

The present application is directed to a misting device capable of selectively spraying a fluid mist to an area or an individual(s) to cool or provide moisture to the area or individual and/or promote health and wellness of the individual(s).

In one exemplary embodiment, the misting device includes a body, a pump, one or more fluid reservoirs, and one or more misting nozzles supported by the body, such as for example, mounted on a spray arm that extends from the body. In another exemplary embodiment, a rigid spray aim extends overhead and includes one or more misting nozzles for directing mist toward one or more areas. In yet another exemplary embodiment, the body supports the device on a surface and the position of the spray arm is adjustable relative to the surface and the orientation of the misting nozzles are adjustable relative to the spray arm.

Further aspects and concepts will become apparent to those skilled in the art after considering the following description and appended claims in conjunction with the accompanying drawings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of the invention:

FIG. 1 is a schematic representation of an exemplary embodiment of a misting device as disclosed in the present application;

FIG. 2 is a perspective view of a second exemplary embodiment of a misting device as disclosed in the present application;

FIG. 3 is side view of the exemplary embodiment of FIG. 1;

FIG. 4 is a schematic representation of a third exemplary embodiment of a misting device as disclosed in the present application;

FIG. 5 is front schematic view of a spray aim with multidirectional mist nozzles of a fourth exemplary embodiment of a misting device as disclosed in the present application;

FIG. 6 is a schematic representation of a fifth exemplary embodiment of a misting device as disclosed in the present application;

FIG. 7 is a perspective view of a sixth exemplary embodiment of a misting device as disclosed in the present application;

FIG. 8 is an exploded view of the device of FIG. 7;

FIG. 9 is an exploded view of an embodiment of a base for the device of FIG. 7;

FIG. 10 is a partial perspective view of the device of FIG. 7;

FIG. 11 is an exploded view of a pump support assembly of the device of FIG. 7;

FIG. 12 is an exploded view of a support tray assembly of the device of FIG. 7;

FIG. 13 is a cross sectional view of an embodiment of a spray arm for the device of FIG. 7;

FIG. 13A is a perspective view of an embodiment of a nozzle assembly for the device of FIG. 7;

FIG. 14 is a partial schematic of the flow system of the device of FIG. 7;

FIG. 15 is a top view of the device of FIG. 7 illustrating movement about a first axis; and

FIG. 16 is a side view of the device of FIG. 7 illustrating movement about a second axis.

### DETAILED DESCRIPTION

The present application discloses a misting device. While the exemplary embodiments illustrated and described herein are presented in the context of a fluid misting device having a cubical or spherical body, a pump, a removable fluid reservoir, and an overhead spray arm that includes a plurality of downward facing misting nozzles, those skilled in the art will readily appreciate that the present invention may be used and configured in other ways. For example, the body may be any suitable shape or size that may support one or more misting nozzles associated with the device. In addition, the fluid reservoir may be fixed within the body or formed as a portion of the body or the device may be adapted to attach to a fluid source, such as a water faucet. Furthermore, the device may mount the one or more misting nozzles in a variety of ways. For example, the one or more nozzles may be mounted on any portion of the spray arm and the one or more nozzles themselves may be pivotally or adjustably mounted to the spray arm to allow for adjustment of the direction of mist exiting the nozzles. The device may also include more than one spray arm such that the nozzles are mounted to two or more spray arms.

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, control logic and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated. The embodiments described in the summary and throughout the specification are not intended to limit the meaning or scope of the claims in any way. The terms used in the claims have all of their full ordinary meaning.

FIG. 1 schematically illustrates an exemplary embodiment of a fluid misting device 100 as disclosed in the present application. The device 100 generally includes a body 102, a fluid reservoir 104, a pump 106 for drawing fluid from the reservoir, and one or more misting nozzles 108 in fluid communication with the pump. The device 100 is configured such that, in operation, the pump 106 draws fluid from the reservoir 104 and delivers the fluid, under pressure, to the one or more misting nozzles 108. The one or more misting nozzles 108 are adapted and arranged to mist the fluid toward one or more particular areas. The device 100 may be adjustable to allow the nozzles 108 to be positioned as desired for misting in one or more desired directions. A means for supporting the misting nozzles 110 is provided. The means for supporting the misting nozzles 110 may be, for example, a support arm that positions the nozzles distal from the body 102. For example, the means for supporting the misting nozzles 110 may be adapted to support the nozzles overhead of an individual or overtop of particular area to be misted.

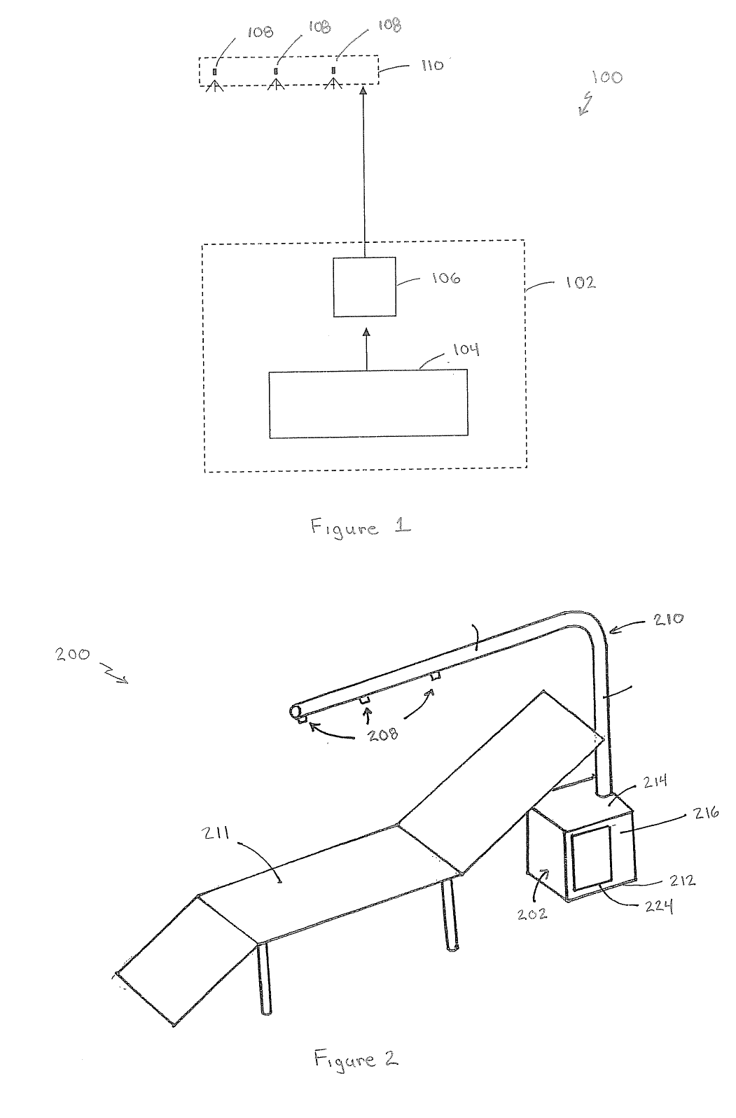

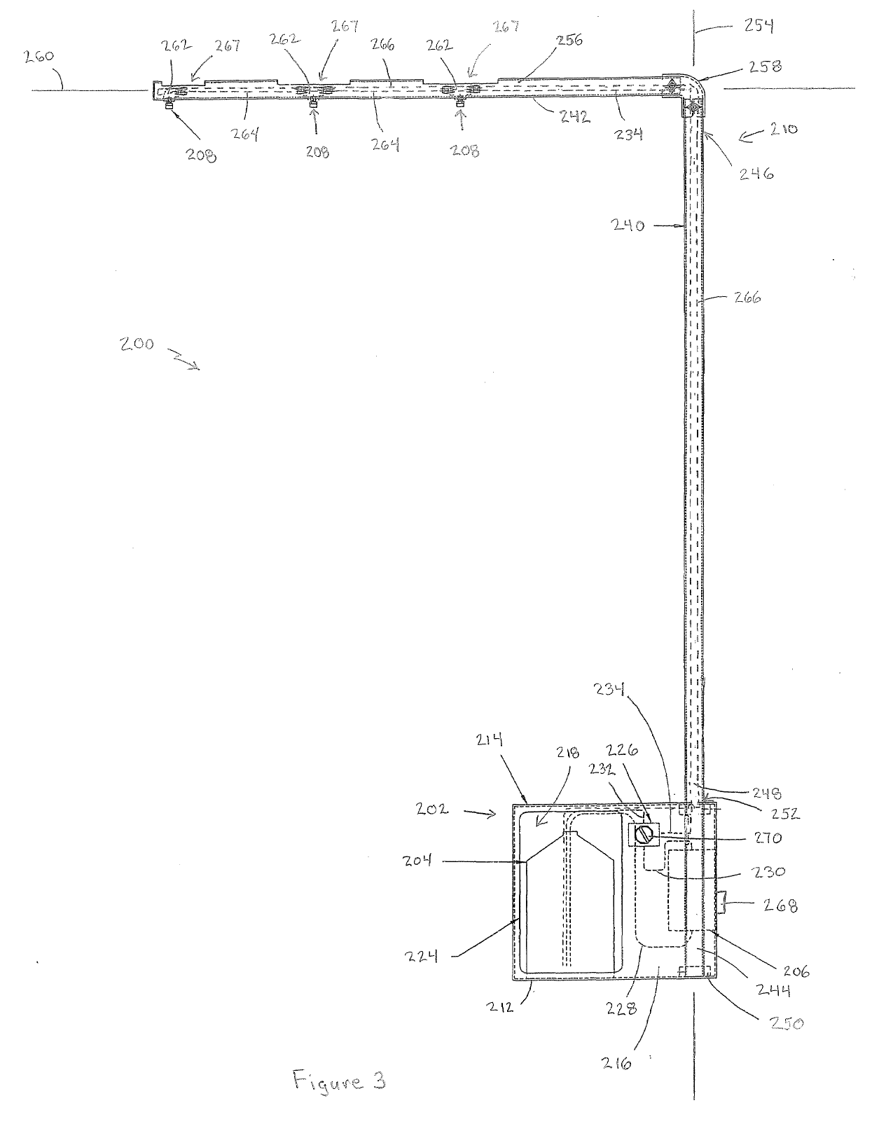

FIGS. 2 and 3 illustrate a second embodiment of the fluid misting device 200 as disclosed in the present application. The device 200 generally includes a body 202, a fluid reservoir 204, a pump 206 for drawing fluid from the reservoir, and one or more misting nozzles 208 in fluid communication with the pump. The misting nozzles 208 are supported by a spray arm 210 for directing mist towards one or more individuals or localized areas, such as for example toward a sunbather on a lounge chair 211 (FIG. 1).

Referring to FIG. 3, the body 202 may be configured in a variety of ways. Any structure capable of supporting one or more spray arms and misting nozzles, providing stability to the device, and/or housing one or more components of the device, may be used. In the depicted embodiment, the body 202 is generally cube-shaped having a generally flat bottom wall 212 for stability, a top wall 214, and a plurality of side walls 216. The generally flat bottom wall 212 allows the device 200 to be self or free standing, however, any suitable shape capable of supporting, alone or in conjunction with additional components, the one or more spray arms 210 and/or misting nozzles 208, may be used. For example, legs or feet may be provided on the device to support the device on a surface. The body 202 may include an internal cavity 218 for housing various components of the device 200. In the depicted embodiment, the body 202 houses the pump 206 and the fluid reservoir 204. Additional or other components, however, may be housed in or supported by the body 202.

The fluid reservoir 204 may be configured and positioned in a variety of ways. Any structure capable of holding a volume of fluid and be in fluid communication with one or more misting nozzles may be used. In the depicted embodiment, the reservoir 204 is a removable, plastic, one gallon container positioned within the body 202. The reservoir 204, however, may be fixed or integral with the body 202, may be larger or smaller than one gallon, and may be made of any suitable material. In an application in which a cooled or chilled liquid is used in the device 200, the reservoir 204 and/or the body 202 may include insulating material (not shown) to keep the fluid cool. In another embodiment, instead of a reservoir 204, an external source of fluid may be provided to the pump 206. For example, the body 202 may be provided with a hose coupling (not shown) to attach the device 200 to a water main via a hose or other fluid conduit. In this way, the pump 206 would receive water from the hose, increase the pressure of the water and deliver the water to the misting nozzles.

The body 202 includes a feature for allowing the reservoir 204 to be easily removed or installed in the body. In the depicted embodiment, openings 224 are included on one or more of the side walls 216 of the body 202. The openings 224 are sized and configured to allow the reservoir 204 to be easily removed or installed in the body.

The pump 206 is positioned within the cavity 218. The pump 206 may be any suitable style, size or configuration capable of delivering fluid from the reservoir 204 to the nozzles 208 under suitable pressure, such as for example approximately 100 psi. The pump 206 may be powered from any suitable power supply. As non-limiting examples, the pump 206 may be powered by an external electrical source, such as 110 VAC outlet, a battery pack, such as a 12 VDC battery, or solar cells.

The pump 206 is in fluid communication with the reservoir 204 and the nozzles 208 such that the pump draws fluid from the reservoir and delivers the fluid to the nozzles. The pump 206 may fluidly communicate with the reservoir 204 and the nozzles 208 by any suitable means, such as for example by conduit, internal passages, or tubing. In the depicted embodiment, nylon tubing is used to transport fluid from the reservoir 204 to the nozzles 208.

The device 200 includes a flow control device 226 (FIG. 3). The flow control device 226 may be configured in a variety of ways. Any device capable of selectively controlling the flow of fluid through the device may be used. In the depicted embodiment, the flow control device is a three-way valve 226 positioned in-line between the pump 206, the reservoir 204, and the nozzles 208. A first tube 228 fluidly connects the reservoir 204 to the pump 206, a second tube 230 fluidly connects the pump to the three-way valve 226, a third tube 232 fluidly connects the three way valve to the reservoir, and a fourth tube 234 fluidly connects the three way valve to the one or more nozzles 208.

The spray aim 210 is supported by or attached to the body 202. The spray arm 210 may be configured in a variety of ways. Any structure capable of supporting one or more misting nozzles may be used. In the depicted embodiment, the spray arm 210 includes a first member 240 extending from the body 202 and a second member 242 attached to the first member. The spray arm 210, however, may be formed as a single unit or may include more than two members. The one or more misting nozzles 208 are positioned on the second member 242.

The spray arm 210 may be made of any suitable material, such as for example, but not limited to, stainless steel, aluminum, and plastic. In the depicted embodiment, the first member 240 is supported by and extends vertically from the body 202. The first member 240 is a generally cylindrical tube or pipe having a first end portion 244 for attaching to the body 202, a second end portion 246 distal from the body, and an internal passage 248.

The first end portion 244 attaches to the body 202 in any suitable manner. In the depicted embodiment, the body 202 includes a cup portion 250 positioned in the internal cavity 218 on the bottom wall 212 and an opening 252 in the top wall 214. The cup portion 250 and the opening 252 closely receive the first end portion 244 to support the first member 240 vertically. In addition, the first member 240 is rotatable relative to the body 202 about an axis 254, thus allowing the position of the nozzles 208 to be adjusted relative to the body. The first member 240 may be configured to allows the one or more nozzles to be positioned overhead of an individual or overtop of an area to be misted.

The second end portion 246 of the first member 240 attaches to the second member 242. The second member 242 is a generally cylindrical tube or pipe having an internal cavity 256. The first and second members 240, 242 may attach in any suitable manner. For example, in the depicted embodiment, the first and second members 240, 242 are connected by an elbow fitting 258. The elbow fitting 258 is illustrated as a 90 degree elbow such that the second member 242 extends substantially horizontal. The angle of the fitting 258, however, and orientation of the second member 242, may be configured as desired. The second member 242 may be fixably attached to the first member 240 or may be adjustably attached. For example, the second member 242 may be rotatably attached to the first member 240 such that it may rotate about an axis 260 relative to the first member.

The second member 242 may house the one or more misting nozzles 208. In the depicted embodiment, three misting nozzles 208 are supported by the second member 242 substantially inline along the length of the second member. The device 200, however, may include more or less than three nozzles 208 and the nozzles may be arranged in a variety of positions on the device. For example, the nozzles 208 may be arranged other than in-line or may be mounted in or supported by other than the second member 242.

The nozzles 208 may be fixably mounted to the second member 242 or may be adjustably mounted. For example, one or more nozzles 208 may be pivotably mounted to the second member 242 such that the spray direction of the nozzles, relative to the second member, may be adjusted. In the depicted embodiment, the nozzles 208 are fixably attached to elbow or tee fittings 262. The elbow or tee fittings 262 are fluidly connected by tube sections 264. The device 200 may also include a recirculation or return tube 266 fluidly connecting the nozzles 208 to the reservoir 204. A return tube 266, however, is not required.

The nozzles 208 may be any suitable nozzle capable of misting the fluid delivered from the reservoir 204. For example, a misting nozzle capable of operating within a range of approximately 20-250 psi and flowing up to approximately five ounces per minute with no or minimal dripping has been found suitable.

In the depicted embodiment, the pump 206, reservoir 204, the tubes 264, the flow control device 226, and the fittings 262 are internal to the device 200, either within the cavity 218 of the body 202 or within the passages 248, 256 of the first and second members 240, 242, respectively. The spray arm 210 may include one or more openings for accessing the components within the passages 248, 256. In the depicted embodiment, a second member 242 includes an opening 267 radially adjacent each of the fittings 262. The openings 267 allow access to the fittings 262 and the nozzles 208 for repair and/or replacement.

The device 200 also includes a pump control 268 and a valve control 270. The pump control 268 may be configured as a toggle switch or other suitable ON-OFF switch for turning the pump ON and OFF. The valve control 270 may be any control capable switching the state of the valve, such as a manual switch or a solenoid, for example. Both the pump control 268 and the valve control 270 may be mounted onto the body 202.

In operation, the fluid reservoir 204 is filled with a fluid and placed within the body 202. Any fluid or fluid mixture desired to be misted and suitable for misting may be used. For example, the fluid may be water or may be water plus one or more additives, such as, but not limited to, an aromatherapy additive (e.g. essential oils, floral waters, hydrosols, etc.) and skin care additives (e.g. certain vitamins and minerals).

If the pump control 268 is placed in the ON position, the pump 206 will be active and will draw fluid from the reservoir 204 and deliver it to the three way valve 226. The valve control 270 is adapted to move the valve between a first position, in which the fluid delivered by the pump 206 is directed back to the reservoir 204 via the third tube 232, and a second position, in which the fluid delivered by the pump is directed to the nozzles 208 via the fourth tube 234. In the first position, the pump 206 is operating, but no fluid is being misted by the device 200. In the second position, the pump 206 delivers fluid through the spray arm 240 to the nozzles 208 under pressure. The fluid exits the nozzles 208 substantially as a mist and may be directed toward a specific location. Any excess fluid that is not misted from the nozzles 208 returns to the reservoir 204 via the recirculation or return tube 266.

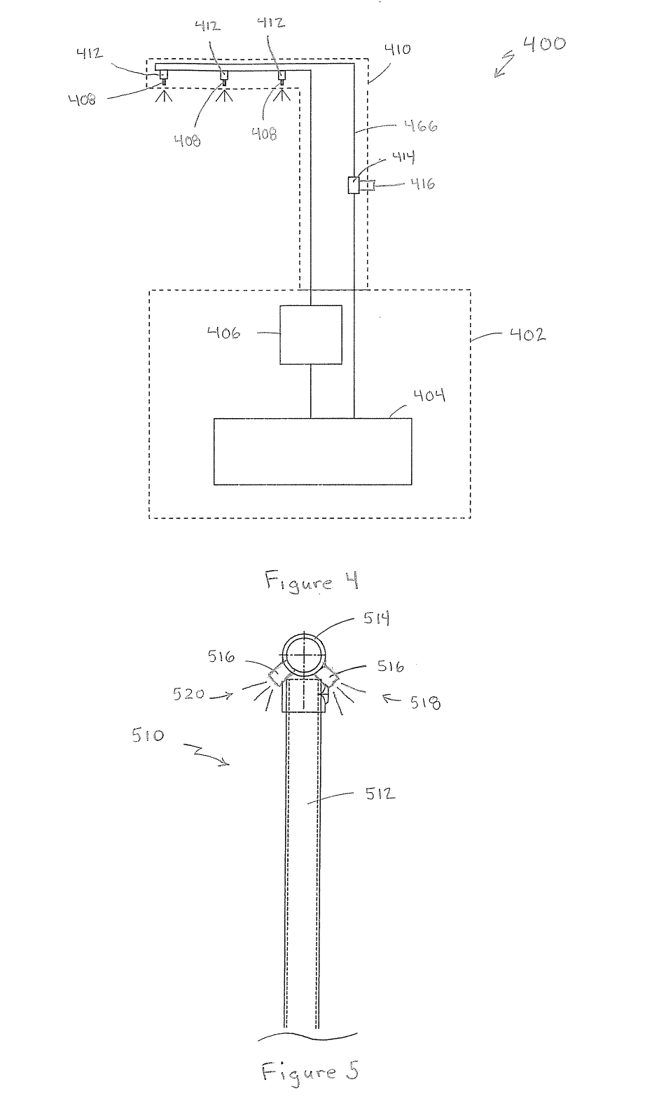

FIG. 4 schematically illustrates a third exemplary embodiment of a fluid misting device. The device 400 is configured substantially similar to the device 200 of FIGS. 2 and 3 in that it generally includes a body 402, a fluid reservoir 404, a pump 406 for drawing fluid from the reservoir, and one or more misting nozzles 408 mounted on a spray arm 410 and in fluid communication with the pump. The device 400 also includes a recirculation or return tube 466 that allows fluid that is delivered to the nozzles 408, but not misted from the nozzles, to return to the reservoir 404. In the depicted embodiment, however, the device 400 does not include a three-way valve and does include a check valve 412 associated with each of the misting nozzles 408. Each check valve 412 is positioned such that fluid directed to a nozzle 408 must pass through the respective check valve before the fluid exits the nozzle. Any suitable check valve 412 with an appropriate cracking pressure may be used, such as for example a cracking pressure of approximately 20 psi.

The device 400 also includes a flow control valve 414 mounted in the return tube 466. The flow control valve 414 may be any device, such as a ball valve for example, capable of opening and closing the flow path through the return tube 466. A valve control 416, such as a handle, toggle, solenoid, or other suitable valve actuating mechanism, may be mounted to the device 400 in a convenient location, such as for example, on the exterior of the body 402 or spray arm 410.

In operation, when the flow control valve 414 is closed and the pump 406 is active, fluid pressure at the nozzles 408 will cause the check valves 412 to open, resulting in the device 400 misting fluid from the nozzles. When the control valve 414 is open, the fluid delivered to the nozzles 408 will circulate back to the reservoir 404 and the fluid pressure will be insufficient to open the check valves 412. Thus, the device 400 will not mist the fluid from the nozzles 408.

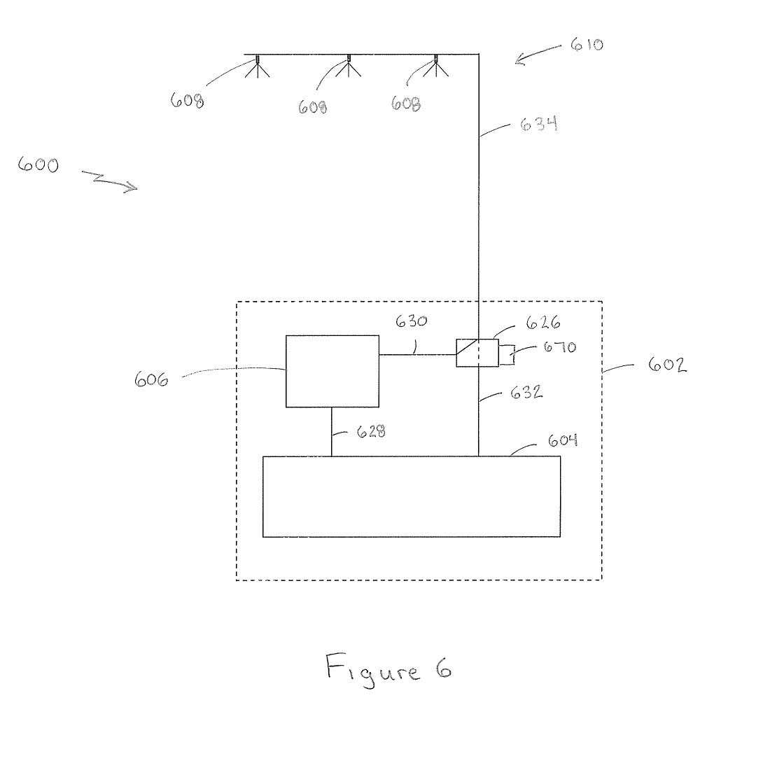

FIG. 5 schematically illustrates another embodiment of a spray arm for a misting device. The spray arm 510 includes a vertical portion 512 and a horizontal portion 514. A plurality of misting nozzles 516 are arranged on the horizontal portion 514. The misting nozzles 516 are arranged in a first group 518 and a second group 520. The first group 518 are configured or arranged to spray mist in a separate direction than the second group 520, though the spray arm 510 may be configured to spray mist in more than two directions. The spray arm 510, therefore, may be utilized on a misting device, similar to the spray arm 210 in the embodiment of FIGS. 2 and 3, to spray mist at two separate individuals or two separate areas at the same time.

FIG. 6 schematically illustrates a fourth exemplary embodiment of a fluid misting device. The device 600 is configured substantially similar to the device 200 of FIGS. 2 and 3 in that it generally includes a body 602, a fluid reservoir 604, a pump 606 for drawing fluid from the reservoir, and one or more misting nozzles 608 mounted on a spray arm 610 and in fluid communication with the pump. The device 600 also includes a flow control device 626, realized as a three-way valve, positioned in-line between the pump 606, the reservoir 604, and the spray arms 634 with the nozzles 608. A valve control 670 is adapted to control the flow control device 626. A first tube 628 fluidly connects the reservoir 604 to the pump 606, a second tube 630 fluidly connects the pump to the three-way valve 626, a third tube 632 fluidly connects the three way valve to the reservoir, and a fourth tube or spray arm 634 fluidly connects the three way valve to the one or more nozzles 608. In the depicted embodiment, however, the device 600, does not include a recirculation or return tube from the nozzles 608. Instead, fluid from the nozzles, may drain back to the reservoir 604 via the fourth tube 634.

In operation, when the three way valve 626 is in a first position, the pump 606 is placed in fluid communication with the nozzles 608 via the second tube 630 and the fourth tube 634. When the three way valve 626 is in a second position, the nozzles are placed in fluid communication with the reservoir 604 via the third tube 632 and the fourth tube 634. Thus, in the first position, the pump 606 delivers fluid to the nozzles 608 under pressure for misting from the device 600. In the second position, no fluid is being misted by the device 600 and any fluid remaining in the spray aim 610 may drain back through the three way valve 626 and into the reservoir 604 via the third tube 632 and the fourth tube 634.

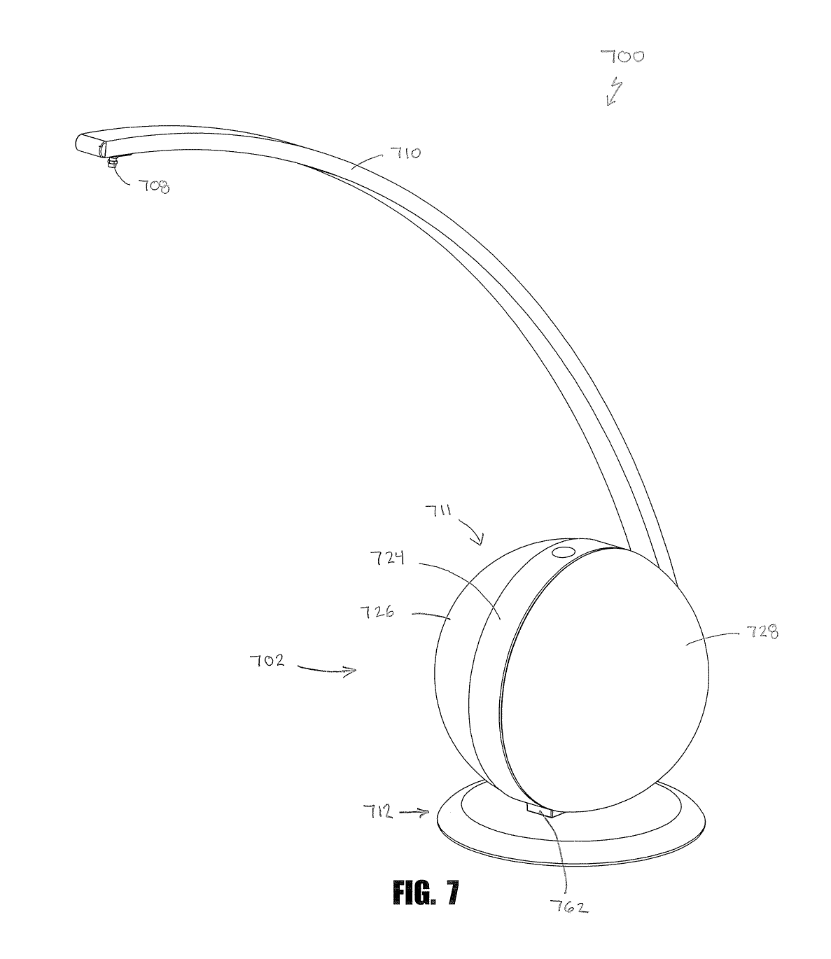

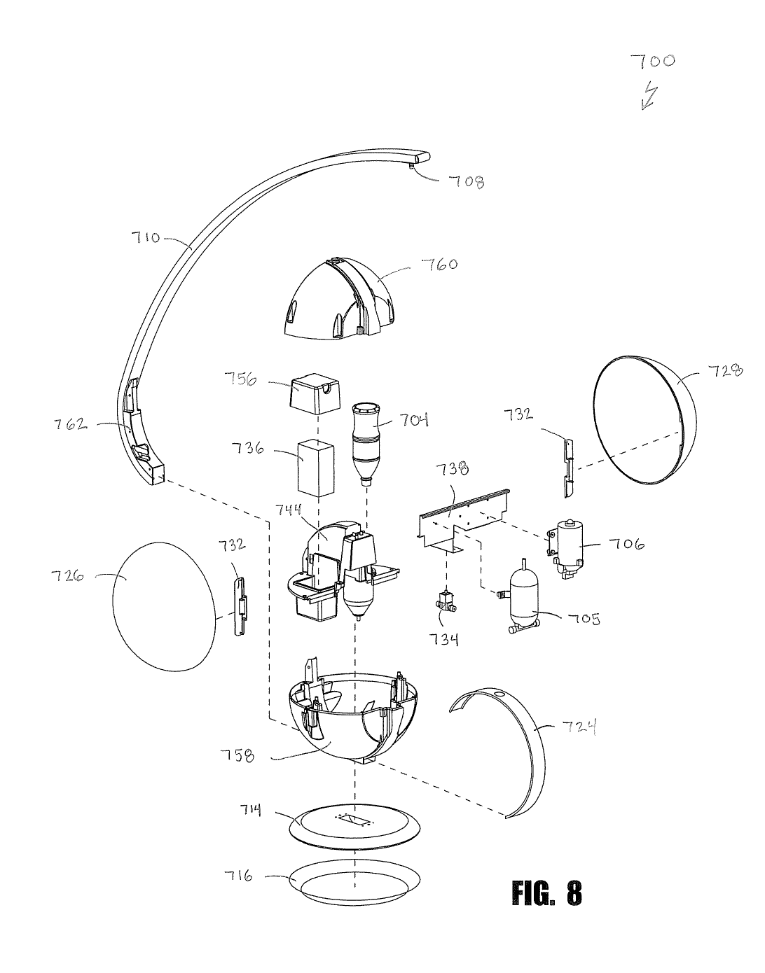

FIGS. 7-16 illustrate a fifth exemplary embodiment of a fluid misting device 700. Referring to FIGS. 7 and 8, the device 700 generally includes a body 702, a first fluid reservoir 704, a second fluid reservoir 705, a pump 706 for drawing fluid from the first fluid reservoir 704, and one or more misting nozzles 708 in fluid communication with the pump. The misting nozzles 708 are supported by a spray arm 710 for directing mist towards one or more individuals or localized areas.

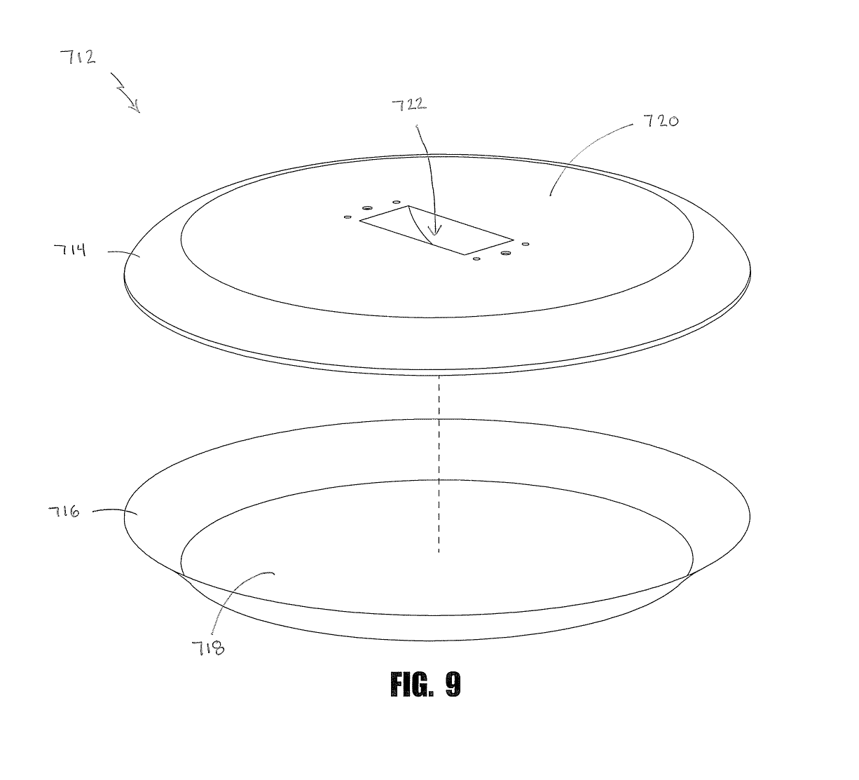

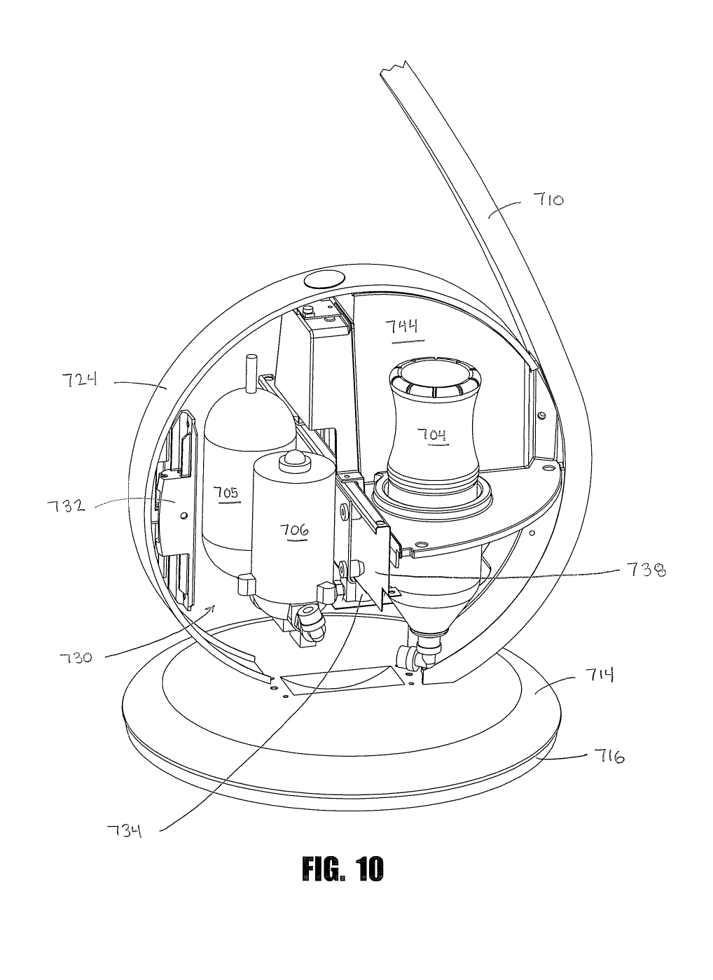

The body 702 may be configured in a variety of ways. Any structure capable of supporting the misting nozzles and providing stability to the device may be used. In the depicted embodiment, the body 702 includes a housing 711 and a base 712. Referring to FIG. 9, the base 712 is a generally flat, circular structure having a top portion 714 rotatably mounted to a bottom portion 716. The base 712, however, in other embodiments, may be shaped other than generally flat or generally circular. The bottom portion 716 has a generally flat bottom surface 718 that allows the device 700 to be placed on a surface 719 (see FIG. 16) and be self or free standing, however, any suitable shape capable of supporting, alone or in conjunction with additional components, the spray arm 710 and the one or more misting nozzles 708, may be used. The top portion 714 has a generally flat top surface 720 and a depression or groove 722 adapted to receive a portion of the spray arm 710. The top portion 714 is rotatably mounted to the bottom portion 716 by any suitable means that allows a user to rotate the top portion relative to the bottom portion without undue strain but provides enough resistance to rotation that the top portion generally stays in position relative to the bottom portion without user input. The means for selectively positioning, therefore, may use friction, detents, or other suitable methods to provide a level of resistance to rotation.

Referring to FIGS. 7 and 8, the housing 711 may be configured in a variety of ways. Any structure capable of housing one or more device components and supporting the spray arm 710 may be used. In the depicted embodiment, the housing 702 is a generally spherical structure including a generally annular frame member 724, a first door 726 pivotally attached to the annular frame member, and a second door 728 pivotally attached to the annular frame member. The frame member 724, the first door 726, and the second door 728 define an internal cavity 730 (FIG. 10) adapted to house one or more components of the device 700. The first door 726 and the second door 728 may be pivotally attached to the frame member 724 in any suitable manner that permits the doors to open sufficiently to provide access to the internal cavity 730. In the depicted embodiment, hinges 732 are used to pivotally mount the doors 726, 728.

In the depicted embodiment, the internal cavity 730 houses the pump 706, the first fluid reservoir 704, the second fluid reservoir 705, a valve 734, a power source 736, such as a battery for example, and additional components for mounting, shielding, and/or supporting other device components (discussed in more detail below).

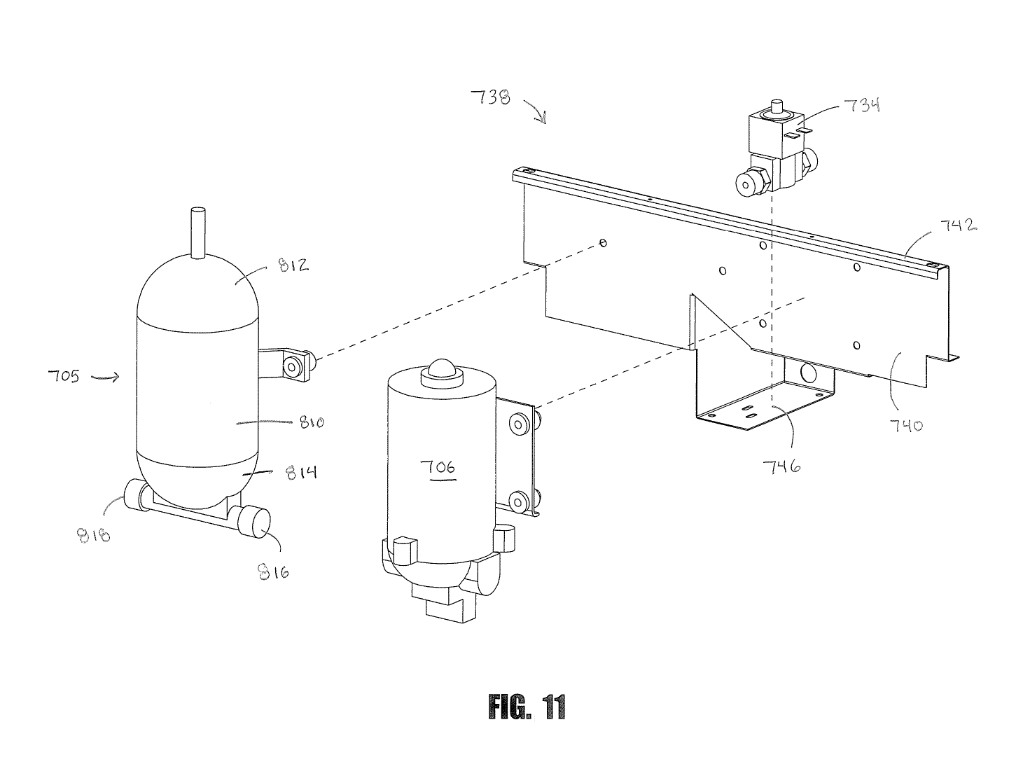

Referring to FIGS. 8 and 11, the pump 706 may be any suitable style, size or configuration capable of delivering fluid from the first fluid reservoir 704 to the second fluid reservoir 705. The pump 706 may be powered from any suitable power source. In the depicted embodiment, the power source 736 is realized as a rechargeable, 12 volt battery. In other embodiments, the device 700 may be adapted to be powered from a 110 VAC outlet, solar cells, other battery configurations, or any other suitable means.

The second fluid reservoir 705 may be configured in a variety of ways. Any device or stricture capable of storing fluid under pressure for delivery to one or more nozzles may be used. In the depicted embodiment, the second fluid reservoir 705 is realized as a compressed gas (or gas-charged) accumulator. The second fluid reservoir 705 has a generally cylindrical body 810 having a first hemispherical end 812 and a second hemispherical end 814. An inlet 816 and an outlet 818 as positioned toward the second end 814. Compressed gas accumulators, as known in the art, generally comprise a body having a first chamber and a second chamber that are separated by an elastic diaphragm. The first chamber is adapted to be filled with and store a fluid and the second chamber contains an inert gas under pressure that provides a compressive force on the fluid in the first chamber to pressurize the fluid. As more fluid is pumped into the first chamber, the gas in the second chamber is compressed, thus changing the pressure of the gas and the pressure on the fluid in the first chamber.

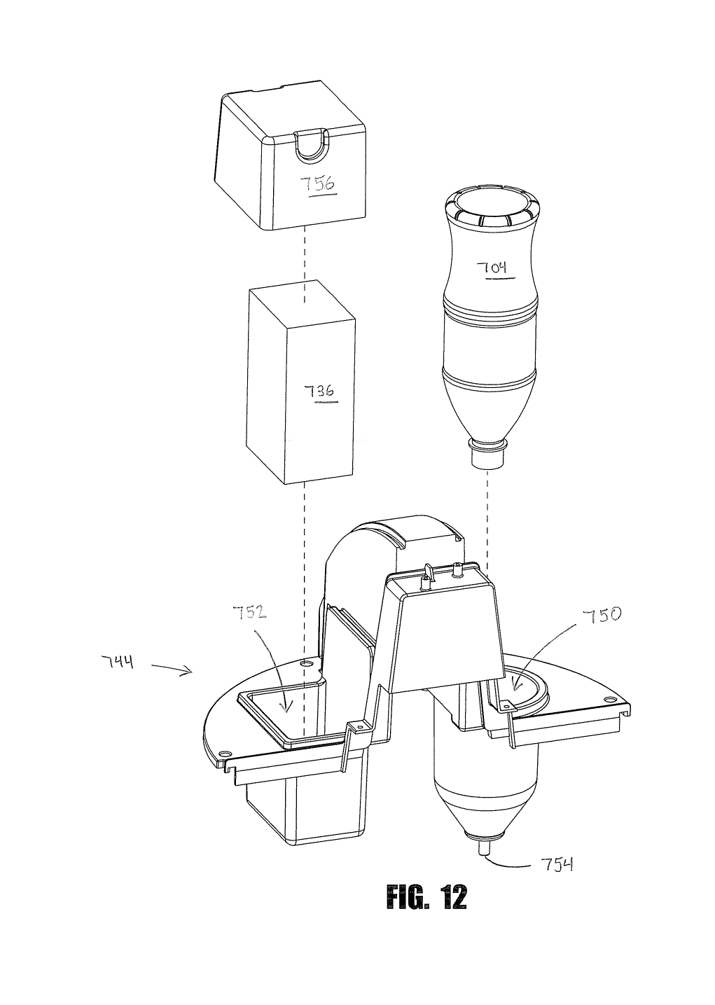

Referring to FIG. 12, the first fluid reservoir 704 may be configured in a variety of ways. Any structure capable of holding a fluid while mounted within the housing 711, and coupling to the pump 706 such that the pump may draw fluid from the first fluid reservoir may be used. In the depicted embodiment, the first fluid reservoir 704 is a removable, plastic container, such as for example a 32 oz or 1 liter plastic bottle having an opening at one end.

Referring to FIG. 11, the pump 706 and the second fluid reservoir 705 mount within the housing 711 to a support bracket 738. The support bracket 738 may be configured in a variety of ways. Any structure capable of supporting the pump 706 and/or the second fluid reservoir 705 in the housing 711 may be used. In the depicted embodiment, the bracket 738 includes a first mounting surface 740 to which the pump 706 and the second fluid reservoir 705 mount, a second mounting surface 742 to which a support tray 744 mounts, and a third mounting surface 746 to which the valve 734 mounts. The pump 706, the second fluid reservoir 705, and the valve 734 may mount to the bracket 738 by any suitable means, such as for example, by fasteners or adhesives.

Referring to FIG. 12, the support tray 744 may be configured in a variety of ways, any structure capable of supporting the power source 736 and/or the first fluid reservoir 704 within the housing 711 may be used. In the depicted embodiment, the support tray 744 includes a first depression or cavity 750 adapted to receive and support the first fluid reservoir 704 and a second depression or cavity 752 adapted to receive and support the power source 736. The first depression 750 is configured to generally follow the contour of the first fluid reservoir 704, though that is not required. The first fluid reservoir 704 and the first depression 750 may be any shape that allows the support tray 744 to support the first fluid reservoir in the housing 711. The first depression 750 includes an opening 754 toward or at the bottom of the first depression for the passage of fluid from the first fluid reservoir 704 to the pump 706. The first depression 750 may also be used as a fluid reservoir if the first fluid reservoir 704 is not used. In other words, a liquid may be placed directly into the first depression 750, which retains the fluid for the pump 706 to draw from.

Referring to FIG. 8, the device 700 includes one or more covers adapted to shield the device components within the housing 711 from liquid that may be sprayed or splashed onto the housing, such as for example, water splashed from a swimming pool. The number of covers and the configuration of the covers may be varied. Any structure capable of shielding the device components within the housing may be used. In the depicted embodiment, the device 700 includes a power source cover 756 adapted to cover the power source 736 when positioned within the second depression 752, a lower housing cover 758 adapted to shield components in the bottom half of the housing 711, and a upper housing cover 760 adapted to shield components in an upper portion of the housing 711.

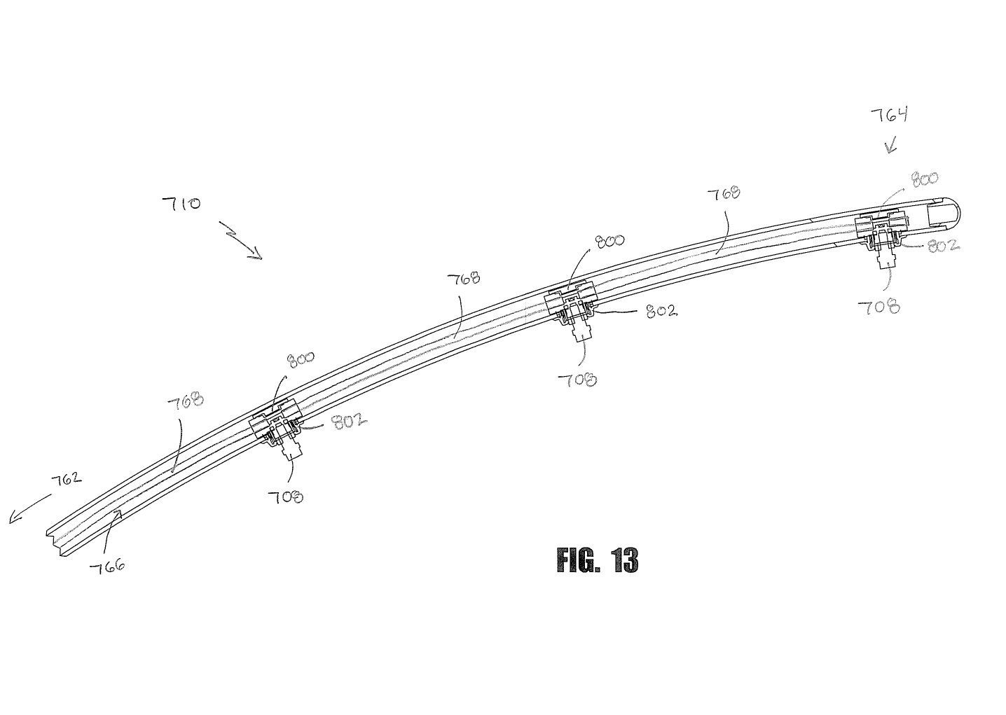

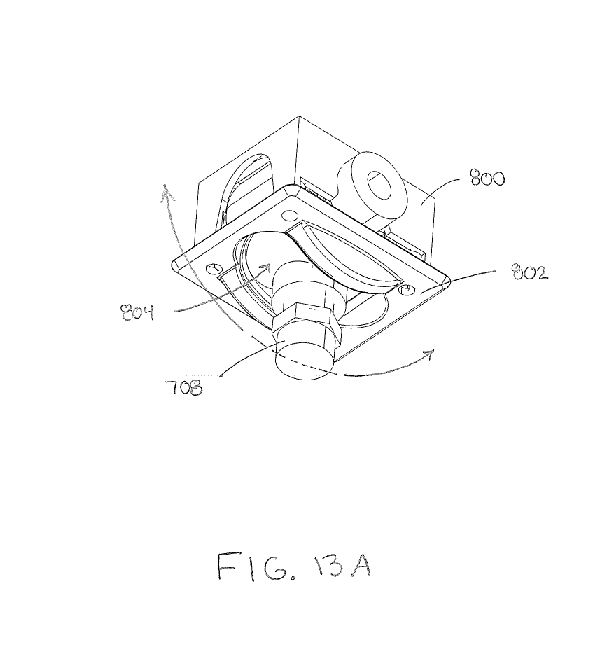

Referring to FIG. 13, the spray arm 710 is attached to the housing 702. The spray arm 710 may be configured in a variety of ways. Any structure capable of supporting the one or more misting nozzles 708 may be used. In the depicted embodiment, the spray arm 710 is a generally rigid, curved structure having a first end portion 762 (FIG. 8) attached to the housing 711, a second end portion 764 distal from the housing, and an internal passage 766. The spray arm 710 is illustrated as a single piece, however, the spray arm may be multiple pieces or sections. The one or more misting nozzles 708 are positioned toward the second end portion 764, though in other embodiments, the nozzles may be located at any position along the spray arm 710. The spray arm 710 may be made of any suitable material, such as for example, but not limited to, stainless steel, aluminum, and plastic.

The first end portion 762 attaches to the housing 711 in any suitable manner that allows fluid communication between the second fluid reservoir 705 and the nozzles 708 in the spray arm 710.

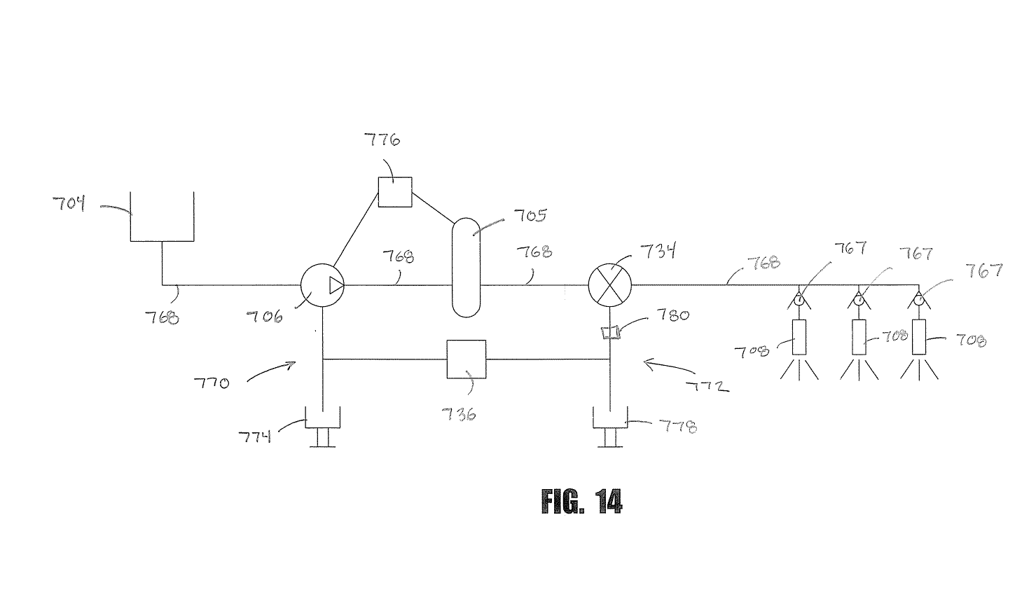

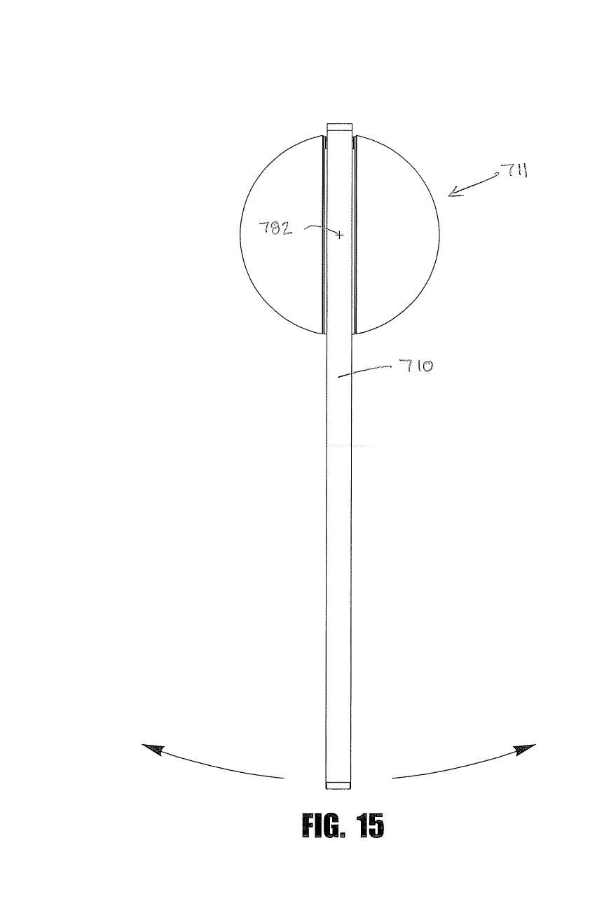

In the embodiment illustrated in FIG. 13, three misting nozzles 708 are supported along the length of the spray arm 710. The device 700, however, may include more or less than three nozzles 708. For example, the spray arm 710 illustrated in FIGS. 7 and 8 includes only one misting nozzle 708. Each nozzle 708 is in fluid communication with the internal passage 766. The nozzles 708 are adjustably mounted on the spray arm 710 such that the nozzles may pivot side-to-side to adjust the direction of the mist. In other embodiments, however, the nozzles may be fixably mounted to the spray arm 710. As illustrated in FIG. 14, a check valve 767 is associated with each of the misting nozzles 708. Each check valve 767 is positioned such that fluid directed to each misting nozzle 708 must pass through the respective check valve before exiting the nozzle. Any suitable check valve 767 with an appropriate cracking pressure may be used, such as for example a cracking pressure of approximately 20 psi.

Referring to FIG. 13 and 13A, each nozzle 708 may be formed as part of a T-shaped configuration or assembly. The nozzle 708 may be housed between a nozzle back housing 800 and a mounting plate 802 defining an oblong opening 804. Each misting nozzle 708 is pivotal within the opening 804 to allow adjustment of the direction of the mist. The nozzle 708 may be any suitable nozzle capable of misting the fluid delivered from the second fluid reservoir 705. For example, a misting nozzle capable of operating within a range of approximately 20-250 psi and flowing up to approximately five ounces per minute with no or minimal dripping has been found suitable.

Referring to FIG. 10 and 14, in an assembled configuration, the pump 706 is in fluid communication with the first fluid reservoir 704 and the second reservoir 705 such that the pump draws fluid from the first reservoir and delivers the fluid to the second reservoir, where the fluid is stored under pressure. The second fluid reservoir 705 is selectively in fluid communication with the nozzles 708 such that the pressurized fluid may be delivered to the nozzles for misting. The first fluid reservoir 704, the pump 706, the second fluid reservoir 705, and the nozzles 708 may fluidly communicate by any suitable means, such as for example, by conduits, internal passages, or tubing. In the depicted embodiment, nylon tubing 768 (FIGS. 13 and 14) is used to transport fluid from the first reservoir 704 to the second reservoir 705 and to the nozzles 708.

The valve 734 is positioned in-line between the second fluid reservoir 705 and the nozzles 708. When the valve 734 is open, the pressurized fluid in the second fluid reservoir 705 flows to the nozzles 708. When the valve 748 is closed, fluid flow between the second fluid reservoir 705 and the nozzles 708 is blocked. Any suitable valve may be used. In the depicted embodiment, the valve 734 is a normally closed, solenoid actuated valve.

The device 700 includes a power circuit 770 and a valve control circuit 772. The power circuit includes a first ON-OFF switch 774, such as a push button, toggle switch or other suitable device and a pressure sensing device 776 for sensing the pressure in the second fluid reservoir 705. The valve control circuit includes second ON-OFF switch 778, such as a push button, toggle switch or other suitable device for actuating the valve and a timer device 780 used to automatically close the valve 748 after a predetermined time period.

In operation, the first fluid reservoir 704 is filled with a fluid to be misted and placed within the support tray 744. For example, the first fluid reservoir 704 may be a conventional plastic bottle, such as a water bottle. The bottle may be opened and turned upside down and placed in the first depression 750 in the support tray 744 such that the water may be drawn from the bottle by the pump via the opening 754 toward or at the bottom of the first depression.

The first fluid reservoir 704 may be filled with any fluid or fluid mixture desired to be misted and suitable for misting. For example, the fluid may be water or may be water plus one or more additives, such as, but not limited to, an aromatherapy additive (e.g. essential oils, floral waters, hydrosols, etc.) and skin care additives (e.g. certain vitamins and minerals).

If the power control ON/OFF switch 774 is placed in the ON position, the pump 706 will be active and capable of drawing fluid from the first fluid reservoir 704. The pressure sensing device 776 is configured to provide a signal indicative of the pressure in the second fluid reservoir 705. The pump 706 is adapted to turn ON or OFF as a function of the sensed pressure. If the pressure in the second fluid reservoir 705 is below a first pressure, the pump 706 will turn on and deliver fluid from the first fluid reservoir 704 to the second fluid reservoir 705. If the pressure is above second pressure, the pump 706 will stop. In this way, the pump 706 only runs when it is needed to fill the second fluid reservoir 705.

The valve control circuit 772 is adapted to open and close the valve 734. When the second ON/OFF switch 778 is placed in the ON position, the valve 734 opens for a predetermined amount of time as set by the timer device 780. For example, in one embodiment, the timer device is set for a 2 second interval, thus the valve 734 is held open for two seconds allowing the nozzles to mist fluid for two seconds. The second ON/OFF switch is adapted to return to the OFF position once released.

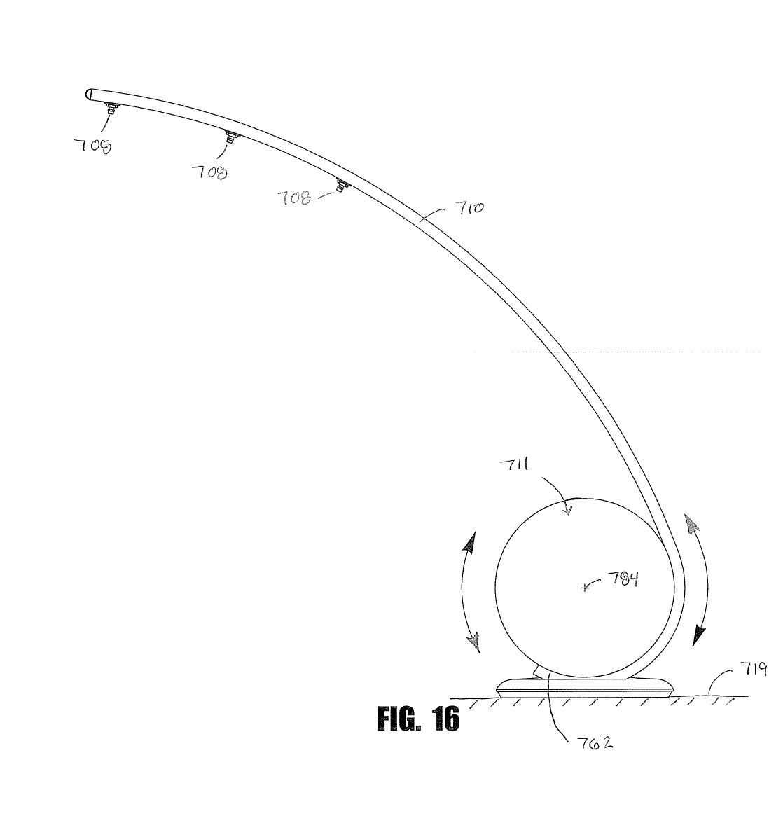

The housing 711 and the misting arm 710 are configured to be adjustable to allow the position of the misting nozzles to be adjusted. As indicated above, the housing 711 is mounted to the top portion 714 of the base 712 and the top portion of the base is rotatably mounted to the bottom portion 716. Thus, as shown in FIG. 15, the housing 711 and the spray arm 710 are rotatable about a first axis 782 to adjust the position of the nozzles 708. The housing 711 and the spray arm 710 may rotate 360 degrees about the first axis 782 to move the nozzles 708 generally parallel to the surface 719 around the axis.

Referring to FIG. 16, the housing 711 and the spray arm 710 are also rotatable about a second axis 784 to adjust the height of the nozzles 708 relative to the surface 719. in the depicted embodiment, the second axis 784 is generally horizontal and the spray arm 710 is movable to any position between a first or raised position and a second or lowered position. The amount of rotation of the housing 711 and the change in height of the spray arm 710 may vary for different embodiments of the device. For example, in one embodiment, the housing 711 is rotatable about 20 degrees, which raises and lowers the second end portion 764 of the spray arm 710 about 18 inches.

As indicated above, the top portion 714 of the base 712 has a depression or groove 722 into which the first end portion 762 of the spray arm 710 is slideably received. The first end portion 762 of the spray arm 710 may be supported within the depression or groove 722 in a variety of ways. Any connection that allows the spray arm 710 and the housing 711 be supported by the base and allows the housing to rotate about the second axis 784 may be used. For example, the first end portion 762 of the spray arm 710 may include a pin or other extension that cooperates with a slot or recess in the groove 722 of the base 712. The interaction between the pin and the slot supports and retains the housing 711 and spray arm 710 on the base 712 while allowing rotation of the housing.

The invention has been described with reference to the preferred embodiments. Modification and alterations will occur to others upon a reading and understanding of this specification. It is intended to include all such modifications and alterations insofar as they come within the scope of the appended claims or the equivalents thereof.

We claim:

1. A device for selectively spraying a fluid mist, the device comprising:
a base portion;
a housing mounted onto the base portion;
a first fluid reservoir disposed within the housing;
a pump disposed in the housing, the pump in fluid communication with the first fluid reservoir;
a rigid spray arm fixably attached to the housing;
a misting nozzle attached to the spray arm, and
a valve disposed within the housing, the valve having a first position that places the pump in fluid communication with the misting nozzle allowing pressurized fluid to flow from the pump to the misting nozzle and a second position that blocks the flow of fluid from the pump to the misting nozzle.

2. The device of claim 1 further comprising a second fluid reservoir disposed within the housing, the second fluid reservoir in fluid communication with the pump for receiving fluid drawn from the first fluid reservoir by the pump, wherein the second fluid reservoir is adapted to store the fluid under pressure.

3. The device of claim 2 further comprising a pressure sensing device configured to sense the pressure in the second fluid reservoir, wherein the pump draws fluid from the first fluid reservoir as a function of the sensed pressure in the second fluid reservoir.

4. The device of claim 2 further comprising a rechargeable battery disposed in the housing, wherein the rechargeable battery supplies power to actuate the valve and operate the pump.

5. The device of claim 1 wherein the housing is rotatable about a generally horizontal axis and rotatable about a generally vertical second axis.

6. The device of claim 1 wherein the base portion comprises a top portion to which the housing is mounted and a bottom portion adapted to support the device on a surface, wherein the top portion is rotatable relative to the bottom portion.

7. The device of claim 1 wherein the spray arm is adjustable to raise and lower the height of the nozzles relative to the base.

8. The device of claim 1 wherein the valve automatically changes from the first position to the second position after a set period of time.

9. The device of claim 1 wherein misting nozzle is pivotally relative to the spray arm.

10. A device for selectively spraying a fluid mist, the device comprising:
a base for supporting the device on a surface;
a housing mounted to the base, the housing rotatable relative to the surface about a first axis and a second axis;
a rigid spray arm mounted to the housing, and
a misting nozzle attached to the spray arm,
wherein rotation of the housing about the first axis moves the misting nozzle generally parallel with the surface and rotation of the housing about the second axis changes the height of the misting nozzle relative to the surface.

11. The device of claim 10 wherein the first axis is generally vertical and the second axis is generally horizontal.

12. The device of claim 10 wherein misting nozzle is pivotally mounted to the spray arm.

13. The device of claim 10 further comprising:
a first fluid reservoir disposed in the housing; and
a pump disposed in the housing, the pump in fluid communication with the first fluid reservoir for drawing fluid from the first fluid reservoir.

14. The device of claim 13 further comprising a second fluid reservoir disposed within the housing, the second fluid reservoir in fluid communication with the pump for receiving fluid drawn from the first fluid reservoir by the pump, wherein the second fluid reservoir is adapted to store the fluid under pressure.

15. The device of claim 14 further comprising a valve having a first position in which the valve places the second fluid reservoir in fluid communication with the misting nozzle allowing the pressurized fluid from the second fluid reservoir to flow to the misting nozzle and a second position, in which the valve blocks the flow of fluid from the second fluid reservoir to the nozzle.

16. The device of claim 14 further comprising an ON/OFF switch, wherein in the ON position, the pump draws fluid from the first reservoir as a function of the pressure in the second fluid reservoir.

17. The device of claim 16 further comprising a pressure sensing device configured to sense the pressure in the second reservoir.

18. The device of claim 10 wherein the valve automatically changes from the first position to the second position after a set period of time.

19. The device of claim 10 further comprising a battery disposed in the housing, wherein the battery supplies power to run the pump and actuate the valve.

20. A device for selectively spraying a fluid mist, the device comprising:
a base assembly having a bottom portion adapted to support the device in a surface and a top portion rotatable relative to the bottom portion;
a housing mounted onto the top portion of the base;
a fluid reservoir disposed within the housing;
a pump disposed within the housing, the pump in fluid communication with the fluid reservoir for drawing fluid therefrom;
an accumulator disposed within the housing, the accumulator in fluid communication with the pump for receiving fluid drawn from the fluid reservoir by the pump, wherein the accumulator is adapted to store the fluid under pressure;
a rigid, curved spray arm fixably attached to the housing, the spray arm defining an internal flow passage;
a plurality of misting nozzles attached to the spray arm, the plurality of nozzles in fluid communication with the internal flow passage in series;
a valve disposed within the housing, the valve having a first position that places the accumulator in fluid communication with the internal flow passage allowing pressurized fluid to flow from the accumulator through the internal flow passage to the plurality of misting nozzles and a second position that blocks the flow of fluid from the accumulator to the internal flow passage,
wherein the housing is rotatable about a generally horizontal axis to raise and lower the height of the nozzles relative to the base assembly.

21. A device for selectively spraying fluid from a fluid source as a mist, the device comprising:
a base for supporting the device on a surface, the base defining an internal chamber;
a pump disposed within the internal chamber, the pump in fluid communication with the fluid source;
a plurality of misting nozzles in fluid communication with the pump;
a means for supporting the plurality of misting nozzles above an area to be misted, the means or supporting the plurality of misting nozzles being rotatable about a vertical axis relative to the base; and
a valve disposed within the internal chamber, the valve having a first position for directing fluid to the plurality of misting nozzles and a second position that blocks the flow of fluid from the pump to the plurality of misting nozzles;
wherein the plurality of nozzles are pivotable relative to the means for supporting the plurality of nozzles.
